(19) United States
(12) Patent Application Publication
(10) Pub. No.: US 2026/0063573 A1
(43) Pub. Date: Mar. 5, 2026

(54) TRANSMISSION ELECTRON MICROSCOPE AND OPERATION METHOD THEREOF

(71) Applicant: Kioxia Corporation, Tokyo (JP)

(72) Inventor: Tsubasa IWAMATSU, Yokkaichi (JP)

(73) Assignee: Kioxia Corporation, Tokyo (JP)

(21) Appl. No.: 19/077,921

(22) Filed: Mar. 12, 2025

(30) Foreign Application Priority Data
Sep. 2, 2024 (JP) 2024-150677

(51) Int. Cl. G01N 23/04; G01N 23/06

(52) U.S. Cl. CPC G01N 23/04; G01N 23/06; G01N 2223/505

(57) ABSTRACT

A transmission electron microscope includes a beam irradiation provider; a first lens system located with respect to the beam irradiation provider; a holder located with respect to the first lens system and configured to mount a sample; a second lens system located with respect to the holder; a detection mechanism located with respect to the second lens system; and a controller. The detection mechanism includes: a scintillator configured to detect an electron beam; a light propagation unit through which light converted in the scintillator propagates; and an imaging element configured to receive the light propagating through the light propagation unit. The controller is configured to generate first light intensity data from a signal obtained by detecting the light transmitted through an element using the imaging element, the element configured to change transmittance of light provided through the light propagation unit.

### CROSS-REFERENCE TO RELATED APPLICATION

This application is based upon and claims the benefit of priority from Japanese Patent Application No. 2024-150677, filed Sep. 2, 2024, the entire contents of which are incorporated herein by reference.

### FIELD

Embodiments described herein relate generally to a transmission electron microscope and an operation method thereof.

### BACKGROUND

Nano beam electron diffraction (NBD) and electron energy-loss spectroscopy (EELS) using a transmission electron microscope (transmission electron microscopy (TEM)) are known.

### DESCRIPTION OF THE DRAWINGS

FIG. 1 is a configuration diagram of a transmission electron microscope according to a first embodiment.

FIG. 2 is a configuration diagram of an electron beam detector applied to the transmission electron microscope according to the first embodiment.

FIG. 3A is a plan view of a liquid crystal panel applied to the transmission electron microscope according to the first embodiment.

FIG. 3B is a schematic diagram illustrating a relationship between a liquid crystal control voltage and a position of a liquid crystal cell in the liquid crystal panel applied to the transmission electron microscope according to the first embodiment.

FIG. 3C is a schematic diagram illustrating a relationship between an intensity of light detected after being transmitted through the liquid crystal cell and the position of the liquid crystal cell in the liquid crystal panel applied to the transmission electron microscope according to the first embodiment.

FIG. 4 is a flowchart illustrating an operation method of the transmission electron microscope according to the first embodiment when light transmittance of a liquid crystal element is defined as 1%.

FIG. 5 is a flowchart illustrating the operation method of the transmission electron microscope according to the first embodiment.

FIG. 6A is a configuration diagram of a transmission electron microscope according to a second embodiment.

FIG. 6B is configuration example 1 of a frame mechanism applied to the transmission electron microscope according to the second embodiment.

FIG. 6C is configuration example 2 of the frame mechanism applied to the transmission electron microscope according to the second embodiment.

FIG. 6D is configuration example 3 of the frame mechanism applied to the transmission electron microscope according to the second embodiment.

FIG. 7 is a flowchart illustrating an operation method of the transmission electron microscope according to the second embodiment.

### DETAILED DESCRIPTION

In TEM in the related art, when various locations (pixels) of an imaging element are irradiated with strong light, an output signal is saturated at a location (a pixel) irradiated with light exceeding a dynamic range, and an actual intensity cannot be measured. When irradiation with light exceeding the dynamic range is performed, adjusting a light irradiation intensity is considered. However, because of a common light source, adjusting the light irradiation intensity not to exceed the dynamic range at a location (a pixel) of a part of the imaging element also decreases the light irradiation intensity at another location (pixel) of the imaging element, and the output signal is weakened.

In acquiring a diffraction pattern in TEM, the intensity at a center spot is relatively higher by one or more digits. When a beam stopper is used to avoid damage in TEM, the intensity and a position of the center spot cannot be obtained. Even in EELS, the intensity at a zero loss peak is relatively higher by one or more digits.

Embodiments provide a transmission electron microscope and an operation method thereof capable of adjusting an irradiation intensity for any pixel of an imaging element to any intensity and reducing an intensity of a beam with which a part (a pixel) corresponding to a center spot in NBD or a zero loss peak in EELS is irradiated.

In general, according to one embodiment, a transmission electron microscope includes: a beam irradiation provider; a first lens system located with respect to the beam irradiation provider; a holder located with respect to the first lens system and configured to mount a sample; a second lens system located with respect to the holder; a detection mechanism located with respect to the second lens system; and a controller. The detection mechanism includes: a scintillator configured to detect an electron beam; a light propagation unit through which light converted in the scintillator propagates; and an imaging element configured to receive the light propagating through the light propagation unit. The controller is configured to generate first light intensity data from a signal obtained by detecting the light transmitted through an element using the imaging element, the element configured to change transmittance of light provided through the light propagation unit.

Hereinafter, embodiments will be described with reference to the drawings. In the following description, the same reference numerals are given to the same or similar members, and the description thereof will be omitted as appropriate. In the following description, a direction perpendicular to a liquid crystal panel extending in an XY plane will be referred to as a Z direction. A first direction of arrangement of liquid crystal cells will be referred to as an X direction. A direction that is a second direction of arrangement of the liquid crystal cells and that is perpendicular to the Z direction and the X direction will be referred to as a Y direction. A minus Z direction of a detection mechanism 22 from a beam irradiation unit (or beam irradiation provider) 11 will be defined as downstream, and a plus Z direction will be defined as upstream. For convenience of description, the detection mechanism 22 may be referred to as an electron beam detector. An element 60 may be referred to as a liquid crystal element, a liquid crystal panel, or a liquid crystal cell.

Hereinafter, embodiments will be described with reference to the drawings.

### Configuration of Transmission Electron Microscope

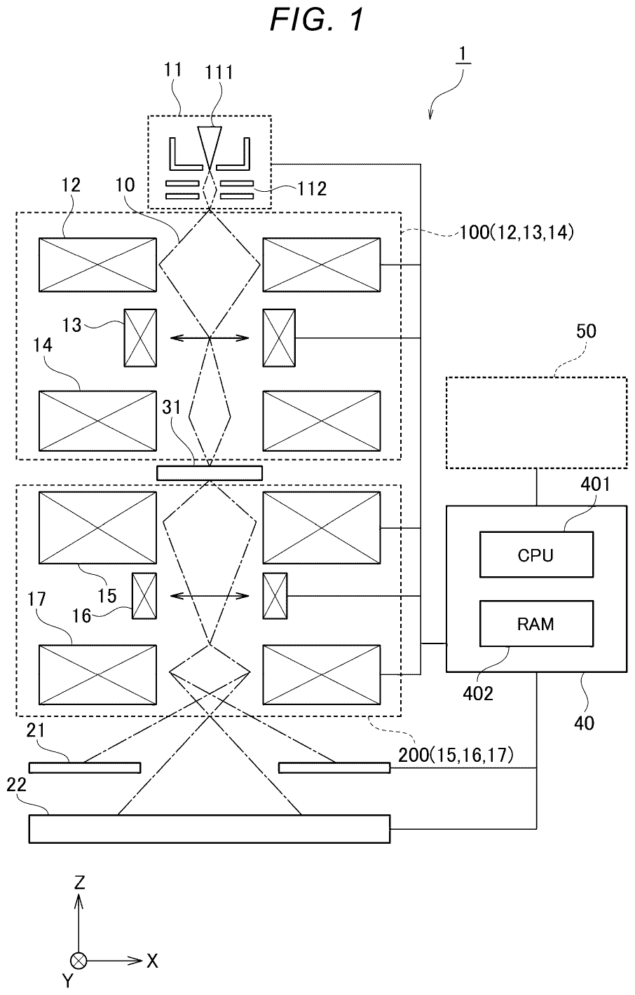

FIG. 1 is a configuration diagram of a transmission electron microscope 1 according to a first embodiment.

As illustrated in FIG. 1, the transmission electron microscope 1 according to the first embodiment includes the beam irradiation unit 11, a first lens system 100 provided downstream of the beam irradiation unit 11, a holder 31 that is provided downstream of the first lens system 100 and on which a sample is mounted, a second lens system 200 provided downstream of the holder 31, a dark field detector 21 provided downstream of the second lens system 200, the detection mechanism 22 provided downstream of the dark field detector 21, and a control unit (or controller) 40.

The first lens system 100 includes a condenser lens 12, a scan coil 13, and an objective lens 14. The second lens system 200 includes an intermediate lens 15, a de-scan coil 16, and a projection lens 17. A lens system may be referred to as a lens mechanism, a coil system, or an emission system.

The beam irradiation unit 11 includes a field-emission electron gun 111 used as an electron source for emitting an electron beam 10, and an acceleration unit 112 that accelerates the emitted electron beam 10. The condenser lens 12 causes the electron beam 10 accelerated in the acceleration unit 112 to converge. The scan coil 13 causes an irradiation position of the electron beam 10 on a surface of the sample to be scanned in the X direction and/or the Y direction. The objective lens 14 causes the electron beam 10 to further converge into a micro electron beam (a nano beam).

The intermediate lens 15 enlarges an electron diffraction image created by the objective lens 14 and forms the enlarged image on an object surface of the projection lens 17 in the subsequent stage. The de-scan coil 16 restores a positional shift of the electron beam 10 from an optical axis caused by the scan coil 13 to the optical axis. That is, the irradiation position of the electron beam 10 can be corrected by shifting the irradiation position of the electron beam 10 in the opposite direction by an amount of the shift of the irradiation position of the electron beam 10 from the optical axis of the condenser lens 12 caused by the scan coil 13.

The projection lens 17 further enlarges the electron diffraction image enlarged by the intermediate lens 15 and forms the further enlarged image on the dark field detector 21 and the electron beam detector 22.

The dark field detector 21 is a ring-shaped electron beam detector having an opening formed in its center part. Electrons scattered or diffracted at a large angle after being transmitted through the sample are detected. The electron diffraction image detected by the dark field detector 21 is a dark field image. The detection mechanism 22 detects electrons that pass through the opening of the dark field detector 21 after being transmitted through the sample. The electron diffraction image detected by the detection mechanism 22 is a diffraction pattern.

The control unit 40 includes a central processing unit (CPU) 401 as a processor, and a random access memory (RAM) 402.

The CPU 401 operates in accordance with a program stored in a memory (not illustrated), and has a control function of controlling an operation and a setting of each part (the beam irradiation unit 11, the condenser lens 12, the scan coil 13, the objective lens 14, the intermediate lens 15, the de-scan coil 16, the projection lens 17, and the like) constituting the transmission electron microscope and also a data analysis function of analyzing the electron diffraction image output from the dark field detector 21 or the electron beam detector 22. That is, the electron diffraction image input from the dark field detector 21 or the electron beam detector 22 is analyzed. For example, when the sample is a crystal, a crystal orientation of a target region is specified.

The CPU 401 controls a voltage to a voltage supply unit of the liquid crystal panel. The CPU 401 calculates second light intensity data OP2 before attenuation from first light intensity data OP1 after attenuation.

The RAM 402 stores data after analysis and various setting values. For example, the RAM 402 may also store a database used for matching with the measured electron diffraction image to specify the crystal orientation.

A relationship between a liquid crystal control voltage and transmittance, and the obtained image are recorded in the RAM 402. The RAM 402 stores characteristic information indicating the relationship between the liquid crystal control voltage and the transmittance of the liquid crystal cell.

### Electron Beam Detector

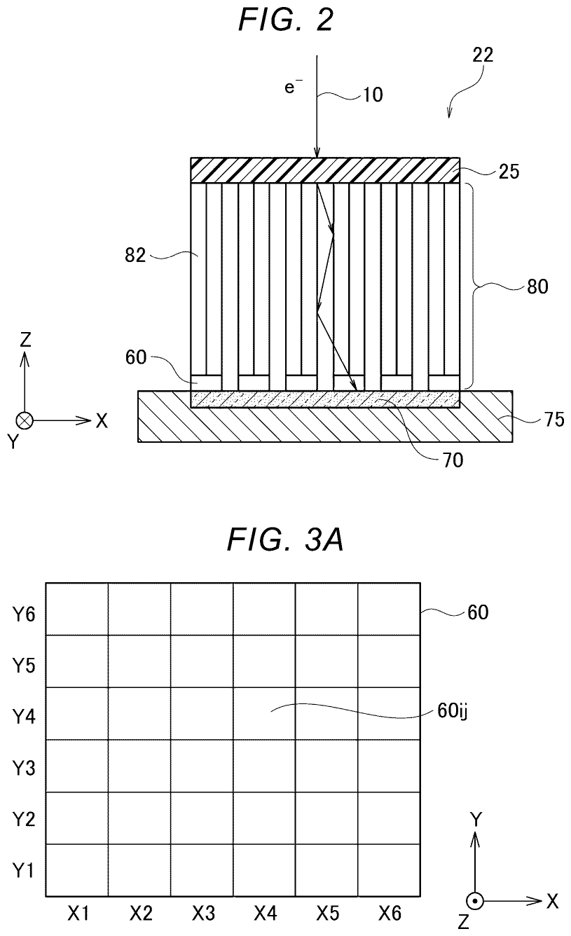

FIG. 2 is a configuration diagram of the detection mechanism 22 applied to the transmission electron microscope 1 according to the first embodiment. The detection mechanism 22 is an electron beam detector.

As illustrated in FIG. 2, the electron beam detector 22 includes a scintillator 25 that detects the electron beam 10, a light propagation unit 80 through which light converted in the scintillator 25 propagates, and an imaging element 70 that receives the light propagating through the light propagation unit 80. The light propagation unit 80 is provided with a plurality of optical fiber bundles 82. The imaging element 70 is provided on a heat sink 75. A charge coupled device (CCD) image sensor or a complementary metal oxide semiconductor (CMOS) image sensor is applicable to the imaging element 70.

As illustrated in FIG. 2, the transmission electron microscope 1 according to the first embodiment includes the element 60 capable of changing the transmittance of light in the light propagation unit 80.

The element 60 includes a liquid crystal element having transmittance changeable in accordance with a supplied voltage, and a voltage supply unit that supplies the voltage. FIG. 2 illustrates an example of the liquid crystal element divided into a plurality of parts as the element 60. The voltage supply unit is a wiring mechanism of supplying the voltage to the liquid crystal element. As illustrated by arrows in FIG. 2, the light converted in the scintillator 25 propagates through the light propagation unit 80 and is incident on the imaging element 70 through the liquid crystal element 60. Intervals illustrated between the liquid crystal cells of the liquid crystal element 60 are used to schematically indicate that the liquid crystal element 60 is divided. The wiring mechanism is formed between the liquid crystal cells or across the liquid crystal cells and thus, not illustrated.

A sol-gel element may be used as another example of the element 60. Impurity of the sol-gel element can be changed by controlling a temperature. Thus, the sol-gel element can change the transmittance of light in combination with a heater element.

### Liquid Crystal Panel

An example of using the liquid crystal panel 60 as the element capable of changing the transmittance of light in the transmission electron microscope 1 according to the first embodiment will be described below.

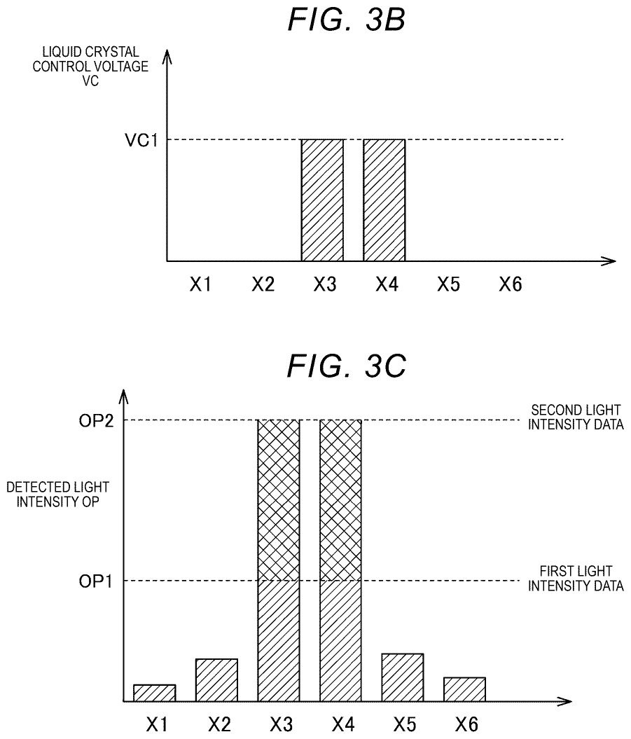

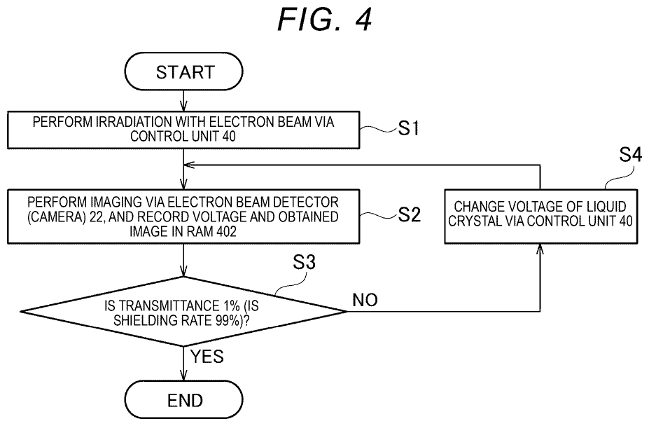

FIG. 3A is a plan view of the liquid crystal panel 60 applied to the transmission electron microscope 1 according to the first embodiment. In the liquid crystal element constituting the liquid crystal panel 60, liquid crystal cells 60ᵢⱼ are laid out as illustrated in FIG. 3A. The wiring mechanism (not illustrated) for supplying the liquid crystal control voltage to be applied to the liquid crystal cells 60ᵢⱼ arranged in the X and Y directions is connected to the liquid crystal panel 60. In FIG. 3A, for example, the liquid crystal cells arranged in the j-th column in the Y direction are denoted by 60₁ⱼ, 60₂ⱼ, 60₃ⱼ, 60₄ⱼ, 60₅ⱼ, and 60₆ⱼ in accordance with positions X1, X2, X3, X4, X5, and X6 of the liquid crystal cells in the X direction. Here, i is an integer of X=1 to 6, and j is an integer of Y=1 to 6.

While the example in FIG. 3A shows a matrix of 6×6 elements by arranging six cells in the X direction and six cells in the Y direction, the present disclosure is not limited to this number. While a specific numerical value example will be described later, approximately 1024 liquid crystal elements are arranged in the vertical and horizontal directions when, for example, one liquid crystal element is mounted on imaging elements of 4×4 pixels.

FIG. 3B is a schematic diagram illustrating a relationship between a liquid crystal control voltage VC and a position X of the liquid crystal cell in the X direction in the liquid crystal panel 60.

FIG. 3C is a schematic diagram illustrating a relationship between a light intensity OP detected after being transmitted through the liquid crystal cell 60ᵢⱼ and the position X of the liquid crystal cell in the X direction in the liquid crystal panel 60.

In the liquid crystal panel 60, the transmittance of light can be changed at any position. The transmittance of light can be continuously changed by changing the liquid crystal control voltage VC applied to each of a plurality of divided liquid crystal cells 60ᵢⱼ. From the relationship between the liquid crystal control voltage VC applied to each liquid crystal cell 60ᵢⱼ and the transmittance, a value of the transmittance before attenuation of light can be obtained by recording the liquid crystal control voltage VC of each liquid crystal cell 60ᵢⱼ during measurement.

The liquid crystal control voltage VC of each liquid crystal cell 60ᵢⱼ is recorded in the RAM 402 in the control unit 40. For example, a personal computer PC can be used as the CPU 401 in the control unit 40. By changing the liquid crystal control voltage VC for each liquid crystal cell 60ᵢⱼ of the liquid crystal panel 60 using the CPU 401, the transmittance of each liquid crystal cell 60ᵢⱼ of the liquid crystal panel 60 can be changed.

The transmittance is measured using the imaging element 70. That is, the transmittance of each liquid crystal cell 60ᵢⱼ of the liquid crystal panel 60 can be measured in pixels of the imaging element 70. While each of the liquid crystal cells 60ᵢⱼ of the liquid crystal panel 60 desirably corresponds one-on-one to the pixels of the imaging element 70, each one liquid crystal cell may correspond to approximately 3×3 to 4×4 pixels.

For example, the control unit 40 for changing the liquid crystal control voltage VC applied to each of the plurality of divided liquid crystal cells 60ᵢⱼ may include a scanning unit in the X and Y directions. The control unit 40 controls which level of the liquid crystal control voltage VC is to be applied to which liquid crystal cell 60ᵢⱼ. Thus, the transmittance in any of each of the liquid crystal cells can be changed. The transmittance of light can be continuously changed by changing the liquid crystal control voltage VC applied to the liquid crystal cell.

In the transmission electron microscope 1 according to the first embodiment, the transmittance of light can be changed at any position by dividing the liquid crystal element 60 into at least a first region and a second region, and supplying any voltage to the first region and the second region via the voltage supply unit.

Changing the transmittance of light at any position means that the transmittance of light can be changed by applying a voltage to a part or all of the elements of the plurality of divided liquid crystal elements arranged in the X and Y directions. For example, the transmittance can be reduced at a location hit by “strong light”. For example, the “strong light” can be defined using the intensity when an upper limit of a dynamic range of 16 bits=65536 gradations is reached (when saturation occurs) in the imaging element as a detection limit of the imaging element.

As illustrated in FIG. 3C, the light intensities detected in the liquid crystal cells 60₁ⱼ and 60₂ⱼ are lower than the first light intensity data OP1. The liquid crystal control voltage VC is sufficiently lower than VC1 and is at a zero level, as illustrated in FIG. 3B. Similarly, as illustrated in FIG. 3C, the light intensities detected in the liquid crystal cells 60₅ⱼ and 60₆ⱼ are lower than the first light intensity data OP1. The liquid crystal control voltage VC here is also sufficiently lower than VC1 and is at a zero level, as illustrated in FIG. 3B. Meanwhile, as illustrated in FIG. 3C, the light intensities detected in the liquid crystal cells 60₃ⱼ and 60₄ⱼ are at a level of the second light intensity data OP2. The transmittance of light in the liquid crystal cells 60₃ⱼ and 60₄ⱼ is decreased by setting a value of the liquid crystal control voltage VC to VC1, as illustrated in FIG. 3B.

In the transmission electron microscope 1 according to the first embodiment, the control unit 40 gradually increases the liquid crystal control voltage VC applied to each of the first liquid crystal cell 60ᵢⱼ and a second liquid crystal cell 60ᵢ₋₁ⱼ of the liquid crystal element 60, and stores the liquid crystal control voltage VC1 when data within the dynamic range is obtained in each of the first liquid crystal cell 60ᵢⱼ and the second liquid crystal cell 60ᵢ₋₁ⱼ, in the RAM 402. The beam irradiation unit 11 performs irradiation based on the stored liquid crystal control voltage VC1, and the first light intensity data OP1 after attenuation is generated. That is, the control unit 40 can generate the first light intensity data OP1 after attenuation from a signal obtained by detecting the light transmitted through the liquid crystal element 60 via the imaging element 70.

In the transmission electron microscope 1 according to the first embodiment, the control unit 40 further includes the RAM 402 storing the characteristic information indicating the relationship between the liquid crystal control voltage and the transmittance for each of the first liquid crystal cell 60ᵢⱼ and the second liquid crystal cell 60ᵢ₋₁ⱼ of the liquid crystal element 60, and the CPU 401 that calculates the second light intensity data OP2 before attenuation corresponding to the intensity of the received light from the first light intensity data OP1 after attenuation based on the characteristic information. The characteristic information indicating the relationship between the liquid crystal control voltage VC and the transmittance is defined as a sum of the original transmittance before applying the liquid crystal control voltage VC and an amount of change in the transmittance after applying the liquid crystal control voltage VC.

The following description uses the examples in FIGS. 3B and 3C.

The control unit 40 gradually increases the liquid crystal control voltage VC applied to each of the first liquid crystal cell 60₄ⱼ and the second liquid crystal cell 60₃ⱼ of the liquid crystal element 60, and stores the liquid crystal control voltage VC1 (FIG. 3B) when data within the dynamic range is obtained in each of the first liquid crystal cell 60₄ⱼ and the second liquid crystal cell 60₃ⱼ, in the RAM 402. The CPU 401 causes the beam irradiation unit 11 to perform irradiation based on the stored liquid crystal control voltage VC1 and generates the first light intensity data OP1 (FIG. 3C) after attenuation.

The RAM 402 stores the characteristic information indicating the relationship between the liquid crystal control voltage VC and the transmittance for each of the first liquid crystal cell 60₄ⱼ and the second liquid crystal cell 60₃ⱼ. The CPU 401 calculates the second light intensity data OP2 (FIG. 3C) before attenuation corresponding to the intensity of the received light from the first light intensity data OP1 (FIG. 3C) after attenuation based on the characteristic information.

### Response Speed

In the transmission electron microscope 1 according to the first embodiment, a response speed to the liquid crystal control voltage and the transmittance of light is several tens of milliseconds or less. Thus, the liquid crystal element is applicable without any problem in operating a TEM camera.

### Arrangement Relationship between Liquid Crystal Cell, Optical Fiber Bundle, and Imaging Element

Coupling between the liquid crystal cell and the optical fiber bundle and an arrangement relationship between the liquid crystal cell and the imaging element will be described.

In order to control the intensity in imaging element units (pixels) using the liquid crystal panel, the number of divisions of the liquid crystal panel desirably corresponds to the number of imaging element units (pixels). That is, the number of liquid crystal cells desirably corresponds one-on-one to the number of pixels of the imaging element. For example, a pixel size of the imaging element is approximately 15 μm square, and a liquid crystal cell size of the liquid crystal panel is approximately 40 μm square or more. Thus, one liquid crystal cell is actually mounted on a plurality of imaging elements (approximately 3×3 to 4×4 pixels). The optical fiber bundle 82 is provided as a bundle of optical fibers. One optical fiber is smaller than the imaging element.

### Sizes of Center Spot, Liquid Crystal Cell, and Imaging Element

For example, a correspondence relationship between a planar size of a center spot and the number of liquid crystal cells in the X and Y directions and a correspondence relationship between the number of liquid crystal cells and the number of pixels of the imaging element will be described using an example of a camera that acquires a spot image.

For example, the pixel size of the imaging element is a square having each side of approximately 15 μm. For example, approximately 4096 elements are arranged in the vertical and horizontal directions. Accordingly, an overall size of the imaging element of the camera is approximately 61 mm square. The size of each liquid crystal cell of the liquid crystal panel is also desirably a square of approximately 15 μm but is actually, for example, approximately 40 μm square to 80 μm square. Thus, as described above, one liquid crystal element is mounted on a plurality of imaging elements (approximately 3×3 to 4×4 pixels). For example, when one liquid crystal element is mounted on the imaging elements of 4×4 pixels, approximately 1024 liquid crystal elements are arranged in the vertical and horizontal directions. For example, the size of the center spot is approximately 200×200 pixels and is approximately 3 mm×3 mm on the imaging elements. The number of cells of the liquid crystal panel is approximately 50×50 cells.

### Current at Which Imaging Element is Saturated

A current value at which one pixel of the imaging element is saturated will be described. A light integral time is set to 0.1 seconds. The scintillator is set to result in 46 counts when one electron hits. Each pixel has a 16-bit gradation area and thus, can be counted up to 65536 counts. That is, the number of counted electrons is calculated as 65536/46=1425. The current value at the moment is 1425×1.6×10⁻¹⁹/0.1=2 fA. When electrons of 2 fA or more are incident on one pixel, one pixel of the imaging element is saturated and cannot be counted. For example, this value is a value easily reached by transmitted electrons in electron energy-loss spectroscopy (EELS) or nano beam electron diffraction (NBD). In the transmission electron microscope 1 according to the first embodiment, by attenuating the light transmitted through the plurality of divided liquid crystal cells, a current level at which the imaging element is saturated can be avoided, and the irradiation intensity for any pixel of the imaging element can be adjusted to any intensity on the camera.

### Zero Loss Peak Intensity

The reason for obtaining the value before attenuation of light by recording the liquid crystal control voltage of each liquid crystal cell will be described. Hereinafter, electron energy-loss spectroscopy (EELS) will be described as an example. The transmission electron microscope uses a thin slice processed to be thin (generally 100 nm or less) enough to allow penetration of the electron beam. The strongest zero loss peak in EELS varies depending on a thickness of the thin slice in an observation area. Conversely, this intensity can be used to estimate the thickness of the thin slice. In obtaining the intensity of the zero loss peak, a background needs to be properly obtained. Thus, the intensity of the zero loss peak is important. Accordingly, since some information can be obtained by obtaining the intensity of the zero loss peak, the value before attenuation needs to be obtained.

### Flowchart for Obtaining Relationship between Liquid Crystal Control Voltage and Transmittance

The relationship between the liquid crystal control voltage VC applied to the liquid crystal element and the transmittance (a light attenuation rate) needs to be obtained before measuring the first light intensity data OP1 after attenuation. The liquid crystal control voltage VC applied to the liquid crystal element is supplied from the control unit 40. The transmittance (the light attenuation rate) is measured in the imaging element 70.

FIG. 4 is a flowchart for obtaining the relationship between the liquid crystal control voltage and the transmittance. This flowchart shows an operation method of the transmission electron microscope according to the embodiment when the light transmittance of the liquid crystal element is defined as 1%. The liquid crystal control voltage VC and the image when the light transmittance (the light attenuation rate) is 1%, that is, a shielding rate is 99%, can be detected using the operation flow in FIG. 4.
(A) First, in step S1, the electron beam detector 22 is irradiated with the electron beam 10 under control of the control unit 40.
(B) Next, in step S2, imaging is executed using the electron beam detector 22 (the camera), and the liquid crystal control voltage VC applied to the liquid crystal element and the obtained image are recorded in the RAM 402 in the control unit 40.
(C) Next, in step S3, whether a measurement result of the transmittance (the light attenuation rate) in the imaging element 70 is 1% (the shielding rate is 99%) is determined.
(D) When a determination result is NO, the flow transitions to step S4, the liquid crystal control voltage VC applied to the liquid crystal element is changed under control of the control unit 40, and the flow returns to step S2.
(E) In step S3, when the determination result is YES, the flow is finished.

With the above operation flow, the relationship between the liquid crystal control voltage VC applied to the liquid crystal element and the transmittance (the light attenuation rate) can be obtained.

### Flowchart of Operation Method of Transmission Electron Microscope

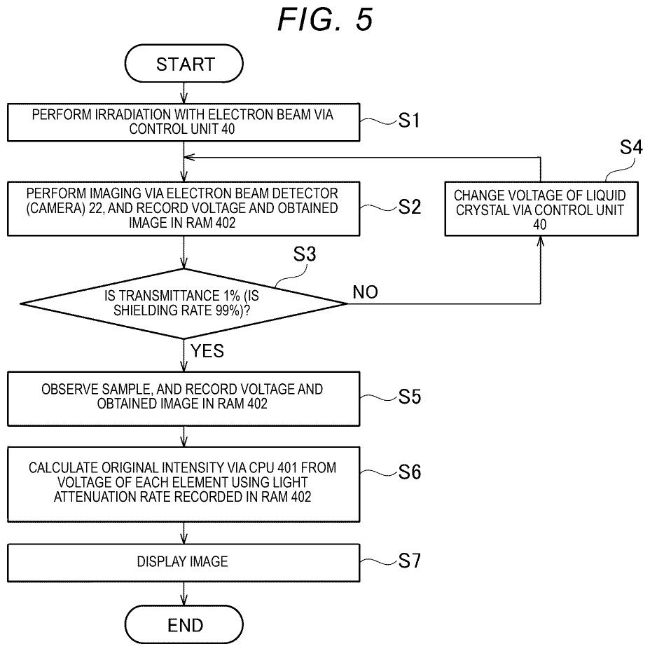

FIG. 5 is a flowchart of an operation method of the transmission electron microscope.

The flowchart for obtaining the relationship between the liquid crystal control voltage VC applied to the liquid crystal element and the transmittance (the light attenuation rate) is the same as FIG. 4.
(F) Next, in step S3, when the determination result is YES, the flow transitions to step S5. The first light intensity data OP1 after attenuation is generated by observing sample and recording the liquid crystal control voltage VC applied to the liquid crystal element and the obtained image in the RAM 402 in the control unit 40.
(G) Next, the flow transitions to step S6, and the second light intensity data OP2 before attenuation is calculated in the CPU 401 from the liquid crystal control voltage VC of each liquid crystal element using the transmittance (the light attenuation rate) recorded in the RAM 402.
(H) Next, the flow transitions to step S7, and calculation of the second light intensity data OP2 before attenuation is displayed on the image. The liquid crystal control voltage applied to each liquid crystal element is recorded during measurement, and the light attenuation rate of each liquid crystal element is already known. Thus, the second light intensity data OP2 before attenuation can be calculated and displayed on the image.

With the above operation flow, the second light intensity data OP2 before attenuation can be calculated from the measurement result of the first light intensity data OP1 after attenuation and displayed on the image.

The transmission electron microscope according to the first embodiment can increase spectrum counts in electron energy-loss spectroscopy (EELS) by adjusting intensity.

The transmission electron microscope according to the first embodiment can clearly acquire a weaker spot and a halo pattern in nano beam electron diffraction (NBD) by adjusting intensity.

The transmission electron microscope according to the first embodiment attenuates the intensity of the center spot by adjusting intensity. Thus, a position of the center spot can be perceived. In addition, how far the attenuation is to be performed can be obtained by calculation. Thus, a bright field image can be obtained by calculation, and its position in the real space can also be perceived.

### Effect of First Embodiment

According to the first embodiment, the transmission electron microscope and the operation method thereof capable of adjusting the irradiation intensity for any pixel of the imaging element to any intensity and reducing the intensity of the center spot can be provided.

### Second Embodiment

### Configuration of Transmission Electron Microscope

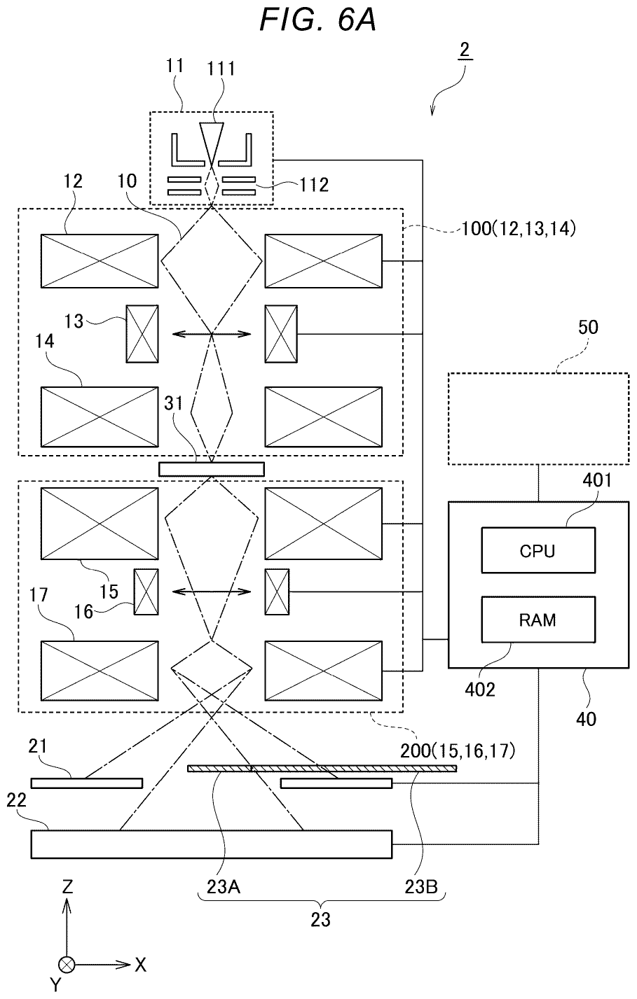

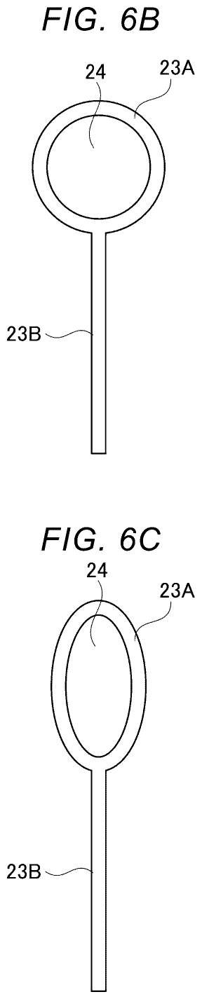

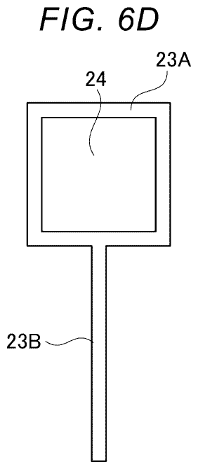

FIG. 6A is a configuration diagram of a transmission electron microscope 2 according to a second embodiment. Hereinafter, differences from the first embodiment will be described, and duplicate descriptions will be omitted.

As illustrated in FIG. 6A, the transmission electron microscope 2 according to the second embodiment includes the beam irradiation unit 11, the first lens system 100 provided downstream of the beam irradiation unit 11, the holder 31 that is provided downstream of the first lens system 100 and on which the sample is mounted, the second lens system 200 provided downstream of the holder 31, the dark field detector 21 provided downstream of the second lens system 200, the detection mechanism 22 provided downstream of the dark field detector 21, and the control unit 40.

The detection mechanism 22 includes the scintillator 25, the light propagation unit 80 through which light converted in the scintillator 25 propagates, and the imaging element 70 that receives the light propagating through the light propagation unit 80. In the transmission electron microscope 2 according to the second embodiment, the element 60 may not be provided in the detection mechanism 22, unlike the element 60 in the first embodiment.

The transmission electron microscope 2 according to the second embodiment includes a film 24 that is provided downstream of the second lens system 200 between the second lens system 200 and the detection mechanism 22 and that reduces an amount of electrons incident on the detection mechanism 22. The film 24 may be provided at any position upstream of the detection mechanism 22. The film 24 may be provided between the second lens system 200 and the dark field detector 21. The diffraction pattern can be acquired using the detection mechanism 22 in a state where the film 24 overlaps with the center spot.

The film 24 is an attenuating (half-transmission) beam stopper film for the electron beam. For example, the half-transmission beam stopper film is a film capable of achieving half transmittance of approximately 1% to approximately 99% for the electron beam. For example, a thickness of the film 24 is approximately 100 nm to 1 μm.

A carbon (C) film or a silicon nitride film (SiN) is applicable to the film 24. As another example, amorphous silicon (a-Si), amorphous germanium (a-Ge), polyvinyl formal, or nitrocellulose may be applied.

A mechanism that can reduce the amount of electrons incident on the detection mechanism 22 to any amount may be provided by inserting a plurality of films 24 with respect to the center spot.

For example, carbon films having different thicknesses may be prepared, films 24 having half transmittance of 25%, 50%, and 75% for the electron beam may be prepared, and the carbon films, the films 24, and the like may be combined with each other. Alternatively, a plurality of the same films 24 may be combined with each other.

### Frame Mechanism

FIG. 6B is a first configuration example of a frame mechanism applied to the transmission electron microscope 2 according to the second embodiment. FIG. 6C is a second configuration example of the frame mechanism applied to the transmission electron microscope 2 according to the second embodiment. FIG. 6D is a third configuration example of the frame mechanism applied to the transmission electron microscope 2 according to the second embodiment. The first configuration example is an example in which a frame 23A has a circular shape. The second configuration example is an example in which the frame 23A has an elliptical shape or an oval shape. The third configuration example is an example in which the frame 23A has an oblong shape. The shape of the frame 23A is not limited to these examples. Any shape that can cover the center spot may be used, such as a triangular shape, a polygonal shape of a pentagonal or more-sided shape, or a cloud shape.

As illustrated in FIGS. 6B to 6D, the film 24 is held by the frame 23A. A frame bar 23B is connected to the frame 23A. As an example of materials of the frame 23A and the frame bar 23B, copper (Cu), molybdenum (Mo), or aluminum (Al) can be used. The frame 23A and the frame bar 23B are desirably small in physical terms. Thus, a solid and easily processable metal may be used. In addition, the frame 23A and the frame bar 23B are desirably conductive in terms of characteristics of the transmission electron microscope 2. In the example in FIG. 6B, a diameter of the frame 23A is approximately 3 mm.

A frame mechanism 23 needs to be present downstream of all electromagnetic lenses and upstream of the electron beam detector 22 in terms of a device configuration. A mechanism of arranging the frame mechanism 23 is a mechanism of moving the frame bar 23B attached to the frame 23A. While the frame mechanism 23 is arranged upstream of the dark field detector 21 in the example illustrated in FIG. 6A, the present disclosure is not limited to this example. The frame mechanism 23 may be arranged at any position upstream of the electron beam detector 22. The frame mechanism 23 may be provided upstream of the electron beam detector 22 and downstream of the dark field detector 21.

### Flowchart of Operation Method of Transmission Electron Microscope

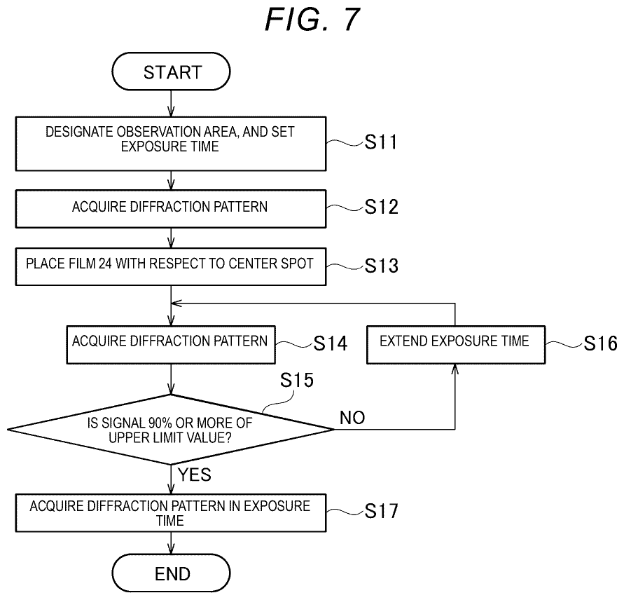

FIG. 7 is a flowchart of an operation method of the transmission electron microscope 2 according to the second embodiment.
(A) First, in step S11, the observation area on the sample is designated, and an exposure time is set. The exposure time may be the minimum exposure time. For example, a value of the minimum exposure time is approximately 0.001 seconds.
(B) Next, in step S12, the diffraction pattern is acquired in the detection mechanism 22 by irradiating the sample with the electron beam 10 under control of the control unit 40.
(C) Next, in step S13, the film 24 held by the frame mechanism 23 is placed at a predetermined position corresponding to the center spot. The center spot is a spot irradiated with a relatively strong electron beam. The predetermined position is a position that is provided between downstream of the second lens system 200 and upstream of the detection mechanism 22 and at which the amount of electrons incident on the detection mechanism 22 is reduced. The position is also a position at which the amount of electrons incident on the detection mechanism 22 is reduced between the second lens system 200 and the dark field detector 21. The film 24 is a film with which the diffraction pattern can be acquired using the detection mechanism 22 in a state where the film 24 overlaps with the center spot.
(D) Next, in step S14, the diffraction pattern is acquired in the detection mechanism 22 by irradiating the sample with the electron beam 10 under control of the control unit 40.
(E) Next, in step S15, whether a signal intensity obtained in the detection mechanism 22 is 90% or more of a saturation level is determined. The saturation level is a value of the signal intensity at which the signal intensity does not change even when the exposure time is extended. For example, the saturation level is a value at which a time derivative value of the signal intensity is close to zero at a threshold voltage level or lower. The saturation level may be defined as a specific upper limit value of the signal intensity. In this case, whether the signal intensity obtained in the detection mechanism 22 is 90% or more of the specific upper limit value is determined in step S15.
(F) Next, when step S15 results in NO, the flow transitions to step S16, the exposure time is extended, and the flow returns to step S14.
(G) Next, when step S15 results in YES, the diffraction pattern is acquired in the extended exposure time, and the flow is finished. Specifically, for example, when the signal intensity obtained in the detection mechanism 22 in step S15 of the (n+1)-th exposure time is 90% or more of the specific upper limit value compared to step S15 of the n-th exposure time, the diffraction pattern is acquired in the (n+1)-th extended exposure time, and the flow is finished.

A result of observing a cross section of a MOS device using the transmission electron microscope 2 according to the second embodiment will be described. Each part of polysilicon, silicon (Si), and a silicon oxide film (SiO₂) is observed.

For the silicon (Si), a diffraction pattern of monocrystalline silicon is observed by creating an NBD mapping (a pseudo-bright field image) using the center spot. The NBD mapping cannot be created when a beam stopper blocking the center spot is used.

For the polysilicon, a diffraction pattern of polycrystalline polysilicon is observed by creating an NBD mapping (a pseudo-bright field image) using the center spot. Even in this case, the NBD mapping cannot be created when a beam stopper blocking the center spot is used.

For the silicon oxide film (SiO₂), an amorphous (SiO₂) diffraction pattern is observed by creating an NBD mapping (a pseudo-bright field image) using the center spot. Even in this case, the NBD mapping cannot be created when a beam stopper blocking the center spot is used. In the example of the amorphous (SiO₂) diffraction pattern, a halo pattern is observed around the center spot because the diffraction pattern is not crystalline.

When the beam intensity of the center spot part is compared based on the above observation result, a trend of an increase in the beam intensity in an order of monocrystalline Si<polycrystalline polysilicon<amorphous (SiO₂) is observed. The intensity of the diffraction pattern can be regarded as an intensity of the bright field image at each point. In the monocrystalline Si, the beam intensity is dispersed in the crystal diffraction pattern around the center spot. Thus, the beam intensity of the center spot part is decreased. In the polycrystalline polysilicon, the beam intensity is dispersed in the diffraction pattern of the polycrystalline part around the center spot. Thus, the beam intensity of the center spot part is decreased. Meanwhile, in the amorphous (SiO₂) diffraction pattern, the beam intensity is not dispersed. Thus, a trend of a relatively high beam intensity of the center spot part is observed. In the monocrystalline Si, the number of counts in the center spot of the diffraction pattern is 65536 counts of 16 bits as its upper limit value and is approximately 60000 counts. Meanwhile, the number of counts is approximately 2000 counts in the diffraction spot and is approximately 400 counts in the halo pattern.

Effect of Second Embodiment The transmission electron microscope according to the second embodiment can acquire a low-intensity spot without damaging the camera and without saturation. In addition, since the position of the center spot is obtained, crystal structure analysis is facilitated.

The transmission electron microscope according to the second embodiment can attenuate only the intensity of the high-intensity spot and consequently, acquire the low-intensity spot in an area hit by the high-intensity spot that is present at the same time as the low-intensity spot, without damaging the camera (without saturation).

According to the second embodiment, the transmission electron microscope and the operation method thereof capable of adjusting only the intensity of the center spot and acquiring the diffraction pattern including the center spot using the same camera can be provided.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A transmission electron microscope comprising:
a beam irradiation provider;
a first lens system located with respect to the beam irradiation provider;
a holder located with respect to the first lens system and configured to mount a sample;
a second lens system located with respect to the holder;
a detection mechanism located with respect to the second lens system; and
a controller,
wherein the detection mechanism includes:
a scintillator configured to detect an electron beam;
a light propagation unit through which light converted in the scintillator propagates; and
an imaging element configured to receive the light propagating through the light propagation unit, wherein
the controller is configured to generate first light intensity data from a signal obtained by detecting the light transmitted through an element using the imaging element, the element configured to change transmittance of light provided through the light propagation unit.

2. The transmission electron microscope according to claim 1,
wherein the element includes a liquid crystal element having transmittance changeable in accordance with a liquid crystal control voltage supplied by a voltage supply unit.

3. The transmission electron microscope according to claim 2,
wherein the transmittance of the light is changeable at any position by dividing the liquid crystal element into at least a first region and a second region, with the first region and the second region supplied with any liquid crystal control voltage via the voltage supply unit.

4. The transmission electron microscope according to claim 3,
wherein the controller further includes:
a memory storing characteristic information indicating a relationship between the liquid crystal control voltage and the transmittance for each of the first region and the second region, and
a calculator configured to calculate second light intensity data corresponding to an intensity of the received light from the first light intensity data based on the characteristic information.

5. The transmission electron microscope according to claim 4,
wherein the controller is further configured to:
increase the liquid crystal control voltage applied to the first region and the second region;
store, in the memory, the liquid crystal control voltage when data within a dynamic range is obtained in each of the first region and the second region;
cause the beam irradiation provider to perform irradiation based on the stored liquid crystal control voltage; and
generate the first light intensity data.

6. The transmission electron microscope according to claim 1, further comprising:
a film provided between the second lens system and the detection mechanism and configured to reduce an amount of electrons incident on the detection mechanism,
wherein a diffraction pattern is acquirable using the detection mechanism in a state where the film overlaps with a center spot.

7. A transmission electron microscope comprising:
a beam irradiation provider;
a first lens system provided with respect to the beam irradiation provider;
a holder provided with respect to the first lens system and configured to mount a sample;
a second lens system provided with respect to the holder;
a detection mechanism provided with respect to the second lens system;
a controller,
wherein the detection mechanism includes:
a scintillator configured to detect an electron beam;
a light propagation unit through which light converted in the scintillator propagates; and
an imaging element configured to receive the light propagating through the light propagation unit; and
a film provided between the second lens system and the detection mechanism and configured to reduce an amount of electrons incident on the detection mechanism,
wherein a diffraction pattern is acquirable using the detection mechanism in a state where the film overlaps with a center spot.

8. The transmission electron microscope according to claim 6,
wherein the film is a half-transmission beam stopper film.

9. The transmission electron microscope according to claim 6,
wherein inserting a plurality of the films with respect to a center spot is configured to reduce the amount of electrons incident on the detection mechanism to any amount.

10. The transmission electron microscope according to claim 6,
wherein a carbon (C) film or a silicon nitride film (SiN) is applicable to the film.

11. A method for operating a transmission electron microscope, the method comprising:
increasing a liquid crystal control voltage applied to a first liquid crystal cell and a second liquid crystal cell of a liquid crystal panel;
storing, in a memory, characteristic information indicating a relationship between the liquid crystal control voltage and transmittance, when obtaining data within a dynamic range in each of the first liquid crystal cell and the second liquid crystal cell;
providing irradiation based on the stored liquid crystal control voltage;
generating first light intensity data after attenuation based on the stored liquid crystal control voltage; and
calculating second light intensity data before attenuation corresponding to an intensity of received light from the first light intensity data based on the characteristic information.

12. An operation method of a transmission electron microscope, the method comprising:
designating an observation area on a sample and setting an exposure time;
acquiring a diffraction pattern in a detection mechanism by irradiating the sample with an electron beam;
placing a film at a position corresponding to a center spot;
acquiring the diffraction pattern in the detection mechanism by irradiating the sample with the electron beam; and
determining whether a signal intensity obtained in the detection mechanism is 90% or more of a specific upper limit value, and when the signal intensity is less than 90%, extending the exposure time, and when the signal intensity is 90% or more, acquiring the diffraction pattern in the extended exposure time.
